(19) United States
(12) Patent Application Publication
(10) Pub. No.: US 2010/0273923 A1
(43) Pub. Date: Oct. 28, 2010

(54) METHOD OF MANUFACTURING COMB POLYMERS BY ADDING AN ANTIOXIDANT, POLYMERS OBTAINED, AND APPLICATIONS THEREOF

(75) Inventors: Jean-Marc Suau, Lucenay (FR); David Platel, Saint Maurice De Gourdans (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COATEX S.A.S., GENAY (FR)

(21) Appl. No.: 12/811,959

(22) PCT Filed: Dec. 11, 2008
(86) PCT No.: PCT/IB08/03478

§ 371 Date: Jul. 7, 2010

(30) Foreign Application Priority Data
Jan. 17, 2008 (FR) 08 00233

(51) Int. Cl. C08K 5/521; C08L 31/00; C08K 5/17

(52) U.S. Cl. 524/145; 524/558; 524/236

(57) ABSTRACT

The invention resides in the implementation of an antioxidant during the functionalization reaction of a (meth)acrylic polymer in a dry state by polyoxyalkylated lateral groups, so as to improve the grafting rate of the final polymer. The obtained polymers constitute another object of the invention, as do the aqueous formulations that they contain.

The present invention relates to the improvement of a method for synthesizing a comb polymer, having a main (meth)acrylic chain onto which are fixed polyoxyalkylated lateral groups.

It is known that such polymers contribute beneficial properties in terms of fluidity, workability, or reducing their water content, particularly to compositions based on hydraulic binders.

For many years, the person skilled in the art has relied upon four methods for preparing such polymers. The oldest one consists of creating a copolymer of maleic anhydride with another hydrophobic monomer in the presence of an organic solvent (like toluene or methylethylcetone), onto which are grafted oxyalkylated lateral chains (for example, see the document WO 97/39037). However, organic solvents remain hazardous substances which are difficult to dispose of.

The second synthesis method consists of copolymerizing, in a solvent or aqueous medium, a (meth)acrylic monomer and a methacrylic polyether macromonomer (see the documents US 2001 001797 and FR 2,861,399). In this case, the high price of the initial (meth)acrylic macromonomer constitutes an obstacle to the implementation of such a method.

A third synthesis method consists of copolymerizing, in a solvent or aqueous medium, a vinylic macromonomer with hanging oxylaklyated chains with a (meth)acrylic monomer (see document US 2004/235687). As before, the price of the initial macromonomer constitutes an obstacle for the person skilled in the art.

There is a fourth synthesis method which consists of esterifying a homo- or copolymer of (meth)acrylic acid using an alkoxy polyoxyalkylene glycol in a solvent medium (see document EP 1,016,638) or aqueous medium (see document FR 2,776,285). Nonetheless, this method does not lead to satisfactory results.

Thus, a new method for manufacturing these comb polymers was developed according to document FR 2,900,930, remedying the drawbacks of the synthesis techniques that implement hazardous solvents or expensive macromonomers, and which lead to higher outputs than those obtained by esterification in an aqueous medium.

The novelty of this method consists of performing the esterification reaction on a homo- or copolymer of (meth)acrylic acid in a dry state. In concrete terms, the homo- or copolymer of (meth)acrylic acid is introduced in dry form into the molten medium containing the groups serving to fulfill the functionalization: the synthesis reaction takes place at a temperature above 100° C. Thus, the reaction time is greatly reduced (leading to a given conversion rate) compared to the same synthesis carried out in an aqueous medium.

In document FR 2,900,930, the conversion rate is measured by acid value through titration of carboxylic functions: the dosed carboxylic functions are the functions which did not react. This document extends the very concept of grafting onto a dry polymer, to amidification reactions with an alkoxy polyoxyalkylene amine and ethoxylation with an alkylene oxide.

Based on the invention produced in document FR 2,900,930, the Applicant has used GPC to dose the quantity of methoxy groups that did not react, when esterifying a polymethacrylic acid by methoxy polyethylene glycol. As demonstrated by tests #1 and #2 of the present Application, the value obtained is high because it is equal to 20% by weight of the initial methoxypolyethylene glycol. However, the method of titrating carboxylic groups reveals a total disappearance of the acidic functions: this demonstrates that the esterification reaction was total.

Seeking to explain such results, which appear contradictory, the Applicant has been able to identify a technical problem heretofore unknown in such a method: the presence of secondary reactions, which seem to be catalyzed by the high reaction temperature, and which lead to a release of the hanging methoxy chains. In order to remedy such a drawback, she then successfully engineered a method for improving the technique proposed by the prior art.

This improvement consists of implementing at least one antioxidant, before and/or after the functionalization stage, which makes it possible to reduce the quantity of the functions which did not react, as determined by GPC. It was therefore sought to very significantly limit the number of secondary oxidative reactions, which lead to a release of the hanging chains: the output of the reaction is greatly improved as a result. Antioxidant refers to a substance possessing the ability to limit the cleavage of molecules and/or the propagation of free radicals.

Besides the very noteworthy technical effect related to implementing this antioxidant, the inventiveness of the present invention further relies on the updating of a technical problem previously unknown in an already-known method: that of releasing the hanging chains from the comb polymer under the effects of temperature. Resolving this problem next, the Applicant successfully improved a fundamental method of the prior art, because it enables the person skilled in the art to bypass hazardous techniques (solvents) and/or costly ones (initial macromonomer). The person skilled in the art therefore has the option of producing, at a low cost with no solvent, quickly and with a high output, comb polymers having a main (meth)acrylic chain on which polyoxyalkylated lateral groups are fixed.

Thus, a first object of the invention consists of a method of manufacturing comb polymers having a main (meth)acrylic chain and polyoxyalkylated lateral groups, consisting of:
a) producing a solution containing at least one homopolymer and/or copolymer of (meth)acrylic acid with at least one other monomer,
b) drying the solution obtained in step a), in view of obtaining a homopolymer and/or a copolymer of (meth)acrylic acid with at least one other monomer in a dry state,
c) mixing the product in a dry state obtained according to step b) with at least one alkoxy polyoxyalkylene glycol in a molten state, and/or at least one alkoxy polyoxyalkylene amine in a molten state, and/or at least one alkylene oxide in a liquid or gaseous state,
d) functionalizing the homopolymer and/or copolymer of (meth)acrylic acid by:
   esterification with at least one alkoxy polyoxyalkylene glycol,
   and/or amidification with at least one alkoxy polyoxyalkylene amine,
   or ethoxylation with at least one alkylene oxide.
      and characterized in that an antioxidant is added during step a) and/or step b) and/or step c).

According to a first preferential variant of the invention, the antioxidant is an amine having at least one aromatic group substituted by an alkyl chain, preferentially two aromatic groups of which at least one is substituted by an alkyl chain having 3 to 9 carbon atoms, and is very preferentially the compound whose CAS number is 68411-46-1. Irganox™ 5057 sold by the company CIBA™ is a commercial example of such a compound.

According to a second preferential variant of the invention, the antioxidant is an organophosphate compound, preferentially an aromatic and/or aliphatic phosphite, and is very preferentially chosen from among the compounds whose CAS numbers are 25550-98-5 and 101-02-0. Doverphos™ 7 and Doverphos™ 10 sold by the company DOVER™ are commercial examples of such compounds.

The Applicant emphasizes that the inventiveness of these 2 preferential variants is particularly supported by the fact that Irganox™ 5057 and Doverphos™ 7 and 10 have until now only been used in very distant technical fields, respectively to stabilize polyurethane foams and polyesters.

The inventive method is further characterized in that step c) is carried out at a temperature between 150° C. and 250° C., preferentially between 180° C. and 220° C.

The inventive method is further characterized in that step c) is carried out in the presence of a catalyst, said catalyst being preferentially chosen between p-toluenesulfonic acid and lithium hydroxide.

The inventive method is further characterized in that the alkoxy polyoxyalkylene glycol is a methoxy polyoxyalkylene glycol, and preferentially a methoxy polyoxyethylene glycol.

The inventive method is further characterized in that the alkoxy polyoxyalkylene amine is a methoxy polyoxyalkylene amine, and preferentially a methoxy polyoxyethylene amine.

The inventive method is further characterized in that the alkylene oxide is an ethylene oxide, or a propylene oxide, or mixtures thereof.

The inventive method is further characterized in that the homopolymer and/or copolymer of (meth)acrylic acid is obtained by methods of radical polymerization in solution, in a direct or inverse emulsion, in a suspension or precipitation in appropriate solvents, in the presence of catalytic systems and transfer agents, or by processes of controlled radical polymerization, and preferentially by nitroxide-mediated (NMP) or cobalt-oxime-mediated polymerization, by atom transfer radical polymerization (ATRP), or by sulphurated derivative-mediated radical polymerization, said derivatives by chosen from among carbamates, dithioesters or trithiocarbonates (RAFT) or xanthates.

The inventive method is further characterized in that the other monomer of the copolymer of (meth)acrylic acid is chosen from among:
at least one ethylene-unsaturated anionic monomer with a monocarboxylic function which is preferentially acrylic or methacrylic acid, or mixtures thereof,
at least one ethylenically-unsaturated monomer, chosen from among at least one ethylenically-unsaturated monomer with a dicarboxylic function, which is preferentially chosen from among crotonic, itaconic, or maleic acid, or from carboxylic-acid anhydrides, and is preferentially maleic anhydride or is chosen from among ethylenically-unsaturated monomers with a sulfonic function and is preferentially chosen from among 2-acrylamido-2-methyl-propane-sulfonic acid, vinylsulfonic acid, or salts of the allyl ether sulfonate acid, the styrene sulfonic acid, or chosen from among ethylenically-unsaturated monomers with a phosphoric function, and is preferentially chosen from among vinylphosphoric acid, ethylene glycol methacrylate phosphate, propylene glycol methacrylate phosphate, ethylene glycol acrylate phosphate, propylene glycol acrylate phosphate, and their ethoxylates, or from among ethylenically-unsaturated monomers with a phosphonic function, and is preferentially vinylphosphonic acid, or chosen from among vinylcaprolactone or vinylpyrrolidone, or mixtures thereof,
at least one water-insoluble monomer, such as alkyl acrylates or methacrylates, or mixtures thereof,
   or mixtures of these monomers.

The inventive method is further characterized in that the drying of the homopolymer and/or copolymer of (meth)acrylic acid carried out according to step b) is performed in a dryer by atomization. However, the person skilled in the art will be able to make use of all drying techniques which are well-known to himself, in order to drive the homopolymer and/or copolymer during step b).

The inventive method is further characterized in that the drying of the homopolymer and/or copolymer of (meth)acrylic acid performed according to step b) is carried out until a solids content level greater than 80% is achieved, preferentially 90%, and very preferentially greater than 95% of the weight of said homopolymer and/or said copolymer, as measured by a halogen moisture analyzer sold by the company METTLER-TOLEDO™ under the name HR83, the measurement being carried out by drying at 150° C. until a loss of mass less than 1 mg is achieved for 30 seconds.

The inventive method is further characterized in that it comprises a potential step e) occurring after step d), which consists of placing the product obtained at the end of step d) into an aqueous solution, then potentially fully or partially neutralizing said product using one or more neutralization agents.

The inventive method is further characterized in that the neutralization agents are chosen from among those with a monovalent neutralizing function and are preferentially chosen from among alkaline cations, and very preferentially chosen from among sodium, potassium, lithium, ammonium, or are preferentially chosen from among primary, secondary, or tertiary aliphatic and/or cyclic amines, and very preferentially chosen from among stearylamine, ethanolamines (mono-, di-triethanolamine), mono- and diethylamine, cyclohexylamine, methylcyclohexylamine, amino-methyl propanol, and morpholine, or are chosen from among neutralization agents having a divalent neutralizing function, and are preferentially chosen from among divalent alkaline-earth cations, and are very preferentially chosen from among magnesium, calcium, and zinc, or are chosen from among neutralization agents having a trivalent neutralizing function and consist preferentially of aluminum, or are chosen from among neutralization agents having a more than trivalent neutralizing function, or are chosen from among mixtures thereof.

A second object of the invention resides in the comb polymers, in a dry state, which have a main (meth)acrylic chain and grafted polyoxyalkylated lateral groups, characterized in that they exhibit a grafting rate greater than 70%, preferentially 80%, and very preferentially 90%, as measured by GPC. Naturally, these polymers are those obtained by the method described above (naturally, without implementing the optional step e) placing them in an aqueous solution).

These comb polymers, in a dry state, are further characterized in that they exhibit a dry solids rate greater than 80%, preferentially greater than 85%, the very preferentially greater than 90%, and extremely preferentially greater than 95% of their weight, as measured by a halogen moisture analyzer sold by the company METTLER-TOLEDO™ under the name HR83, the measurement being carried out by drying at 150° C. until a loss of mass less than 1 mg is obtained for 30 seconds.

A third object of the invention resides in the comb polymers, in an aqueous solution, which have a main (meth)acrylic chain and grafted polyoxyalkylated lateral groups, characterized in that they exhibit a grafting rate greater than 70%, preferentially 80%, and very preferentially 90%, as measured by GPC. Naturally, these polymers are those obtained by the method described above, including implementing the step e) of placing them in an aqueous solution.

A fourth object of the present invention resides in the formulations containing mineral or organic materials, characterized in that they contain at least one comb polymer of the present invention.

These formulations are further characterized in that they are aqueous formulations containing mineral or organic materials, said formulations being chosen from among aqueous dispersions or suspensions of mineral or organic materials, potentially containing a dispersion agent and/or a grinding aid agent and/or an anti-sedimentation agent and/or a thickening agent, or aqueous compositions based on hydraulic binders, and are preferentially concretes, mortars, slags, grouts, plasters, or paper coatings, or paints, or cosmetic or detergent formulations, or textile formulations, or ceramic formulations, or drilling slurries.

The following examples make it possible to better understand the content of the invention, though without limiting its scope.

### EXAMPLES

In all of the examples of the present Application, the esterification rate is calculated by tracking the acid value, which makes possible to determine the proportion of acidic functions which have not reacted (according to the method described in the document FR 2,900,930).

The molecular weight of the manufactured comb polymer, as well as the content of ungrafted methoxy polyethylene glycol, are determined by GPC using the following method.

The chromatographic system is made up of a Waters™ 717 autosampler, an ERC 3112 in-line degasser, an Waters 515 HPLC pump, a column oven, a Waters™ 2410 refractometer, a Viscotek™ T60 A light-scattering viscosimetric detector, a Ultrahydrogel Waters™ guard column, a linear Waters™ Ultrahydrogel column+2 Waters Ultrahydrogel 120 columns (length 30 cm; diameter 7.8 mm) and a computer system with TriSEC 3.0 software. The mobile phase is prepared from a 666 mM parent solution of sodium sulfate filtered at 0.1 μm. 10% of this solution is mixed with 5% of ACN qsp ultra-pure water, neutralized to pH 9 with sodium hydroxide. The flow rate is 0.8 mL/min, the temperature of the columns and the refractometer is 30° C., the sensitivity and the scale factor of the refractometer are respectively equal to 4 and 20. The samples possess 4 dry mg sec of product/ml of mobile phase. They are filtered at 0.2 μm before injection. The injection volume is 100 the analysis time is 50 min. The calibration is carried out with PEO 21k Viscotek™ master with flow correction on the negative water peak and T70K dextran.

### Example 1

This example illustrates the method of the prior art as described in the document FR 2,900,930, and which does not implement any antioxidant.

It starts by taking a solution of a homopolymer of methacrylic acid in a 30% by mass solution in water, and sold by the company COATEX™ under the name TP 941.

This solution is then dried. It is added to the pre-heating chamber at a temperature of 85° C. The product is injected into the atomization chamber of a dryer-atomizer using a nozzle, at a pressure of 60 bars. 300° C. hot air is also injected into the atomization chamber, which causes the flash-evaporation of the water of the polymer solution.

The output of this drying is greater than 99%, meaning that the mass of dry polymer obtained after drying is at least equal to 99% of the mass of polymer contained within the starting aqueous solution.

The temperature of the output polymer is equal to 50° C.

This drying operation is extremely fast, because it lasts only a few seconds. The polymer is then retrieved in the form of a dry powder.

Test No. 1

Next, in a glass 0.25 liter reactor equipped with a mechanical agitation and an electric heater, mix:
80 g of methoxy polyethylene glycol whose molecular mass equal to 2,000 g/mole, sold by the company CLARIANT™ under the name of Polyglykol™ M 2000, in molten from (or 0.04 mole),
0.24 g of lithium hydroxide,
13.8 g of the homopolymer of dry methacrylic acid obtained by the drying method described above (or 0.16 mole of methacrylic acid).

The esterification reaction of the homopolymer of methacrylic acid by methoxypolyethylene glycol then takes place. The whole assembly is then degassed by a current of nitrogen for 20 minutes. While agitating, the temperature is then gradually increased to 190° C., and the whole assembly is placed in a vacuum (20 mm of mercury) with this increase in temperature taking 60 minutes. The mixture is then cooked for 120 minutes at 190° C. The whole assembly is then cooled and diluted with 78.3 g of water, then neutralized with 50% sodium hydroxide to pH 8.4.

Before esterification, the acid value (IAᵢ) of the mixture is equal to 83 mg of potash per gram of product. After esterification, this value (IA_{f}) is equal to 34 mg of potash per gram of product. The result is a total consumption of the alcohol functions that are added. A molecular weight of 155,600 g/mole results. The unreacted methoxypolyethylene glycol content is equal to 20% by weight of the initial methoxy, or a calculated methoxy output actually grafted equal to 57% by weight of the initial methoxy.

Test No. 2

Next, in a glass 0.25 liter reactor equipped with a mechanical agitation and an electric heater, mix:
80 g of Polyglykol™ M 2000, in molten form (or 0.04 mole),
1.9 g of p-toluenesulfonic acid,
13.8 g of the homopolymer of dry methacrylic acid obtained by the drying method described above (or 0.16 mole of methacrylic acid).

The esterification reaction of the homopolymer of methacrylic acid by methoxypolyethylene glycol then takes place. The whole assembly is then degassed by a current of nitrogen for 20 minutes. While agitating, the temperature is then gradually increased to 190° C., and the whole assembly is placed in a vacuum (20 mm of mercury) with this increase in temperature taking 60 minutes. The mixture is then cooked for 120 minutes at 190° C. The whole assembly is then cooled and diluted with 78.3 g of water, then neutralized with 50% sodium hydroxide to pH 8.4.

Before esterification, the acid value (IAi) of the mixture is equal to 83 mg of potash per gram of product. After esterification, it is equal to 35 mg of potash per gram of product. The result is a total consumption of the alcohol functions that are added. A molecular weight of 201,100 g/mole results. The unreacted methoxypolyethylene glycol content is equal to 20.5% by weight of the initial methoxy, or a calculated methoxy output actually grafted equal to 55.5% by weight of the initial methoxy.

These results clearly demonstrate that the high-temperature direct esterification of a methacrylic polyacid is performed with high outputs if the disappearance of the acid function is considered. On the other hand, the high content of free glycol polyethylene demonstrate that the methoxies are not stable for these temperatures, which lead to thermal degradations that produce a release of the hanging chains.

### Example 2

This example illustrates the invention, meaning the method as described in the document FR 2,900,930 and in which an antioxidant is implemented.

Each of the tests #3 to #9 starts by taking a solution of a homopolymer of methacrylic acid and drying it in accordance with steps a) and b) of the inventive method, with a protocol identical to that of tests 1 and 2.

Test No. 3

According to step c) of the inventive method, in a 0.25 liter glass reactor equipped with a mechanical agitation and an electric heater, mix:
80 g of Polyglykol™ M 2000,
0.24 g of lithium hydroxide,
13.8 g of the homopolymer of dry methacrylic acid obtained by the drying method described above (or 0.16 mole of methacrylic acid).
0.20 g of Irganox™ 5057 sold by the company CIBA™.

According to step d) of the invention, the esterification reaction then occurs. The whole assembly is then degassed by a current of nitrogen for 20 minutes. While agitating, the temperature is then gradually increased to 190° C., and the whole assembly is placed in a vacuum (20 mm of mercury) with this increase in temperature taking 60 minutes. The mixture is then cooked for 120 minutes at 190° C. The whole assembly is then cooled and diluted with 128 g of water, then neutralized with 50% sodium hydroxide to pH 8.4.

Test No. 4

According to step c) of the inventive method, in a 0.25 liter glass reactor equipped with a mechanical agitation and an electric heater, mix:
36.1 g of Polyglykol™ M 2000, in molten form,
0.24 g of lithium hydroxide,
15.68 g of the homopolymer of dry methacrylic acid obtained by the drying method described above,
0.18 g of Irganox™ 5057.

According to step d) of the invention, the esterification reaction then occurs. The whole assembly is then degassed by a current of nitrogen for 20 minutes. While agitating, the temperature is then gradually increased to 210° C., and the whole assembly is placed in a vacuum (20 mm of mercury) with this increase in temperature taking 60 minutes. The mixture is then cooked for 30 minutes at 210° C. The whole assembly is then cooled and diluted with 78.3 g of water, then neutralized with 50% sodium hydroxide to pH 8.4.

Test No. 5

According to step c) of the inventive method, in a 0.25 liter glass reactor equipped with a mechanical agitation and an electric heater, mix:
52.1 g of Polyglykol™ M 2000, in molten form,
0.24 g of lithium hydroxide,
15 g of the homopolymer of dry methacrylic acid obtained by the drying method described above,
0.2 g of Irganox™ 5057.

According to step d) of the invention, the esterification reaction then occurs. The whole assembly is then degassed by a current of nitrogen for 20 minutes. While agitating, the temperature is then gradually increased to 210° C., and the whole assembly is placed in a vacuum (20 mm of mercury) with this increase in temperature taking 45 minutes. The mixture is then cooked for 30 minutes at 210° C. The whole assembly is then cooled and diluted with 105 g of water, then neutralized with 50% sodium hydroxide to pH 8.4.

Test No. 6

According to step c) of the inventive method, in a 0.25 liter glass reactor equipped with a mechanical agitation and an electric heater, mix:
44.1 g of Polyglykol™ M 2000, in molten form,
0.24 g of lithium hydroxide,
15.34 g of the homopolymer of dry methacrylic acid obtained by the drying method described above,
0.2 g of Irganox™ 5057.

According to step d) of the invention, the esterification reaction then occurs. The whole assembly is then degassed by a current of nitrogen for 20 minutes. While agitating, the temperature is then gradually increased to 210° C., and the whole assembly is placed in a vacuum (20 mm of mercury) with this increase in temperature taking 45 minutes. The mixture is then cooked for 60 minutes at 210° C. The whole assembly is then cooled and diluted with 89.8 g of water, then neutralized with 50% sodium hydroxide to pH 8.4.

Test No. 7

According to step c) of the inventive method, in a 0.25 liter glass reactor equipped with a mechanical agitation and an electric heater, mix:
80 g of Polyglykol™ M 2000, in molten form,
1.9 g of p-toluenesulfonic acid,
13.8 g of the homopolymer of dry methacrylic acid obtained by the drying method described above,
0.20 g of Irganox™ 5057.

According to step d) of the invention, the esterification reaction then occurs. The whole assembly is then degassed by a current of nitrogen for 20 minutes. While agitating, the temperature is then gradually increased to 190° C., and the whole assembly is placed in a vacuum (20 mm of mercury) with this increase in temperature taking 60 minutes. The mixture is then cooked for 120 minutes at 190° C. The whole assembly is then cooled and diluted with 128 g of water, then neutralized with 50% sodium hydroxide to pH 8.4.

Test No. 8

According to step c) of the inventive method, in a 0.25 liter glass reactor equipped with a mechanical agitation and an electric heater, mix:
80 g of Polyglykol™ M 2000, in molten form,
0.24 g of lithium hydroxide,
13.8 g of the homopolymer of dry methacrylic acid obtained by the drying method described above,
0.20 g of Doverphos™ 7 sold by the company DOVER CHEMICAL™.

According to step d) of the invention, the esterification reaction then occurs. The whole assembly is then degassed by a current of nitrogen for 20 minutes. While agitating, the temperature is then gradually increased to 210° C., and the whole assembly is placed in a vacuum (20 mm of mercury) with this increase in temperature taking 60 minutes. The mixture is then cooked for 30 minutes at 210° C. The whole assembly is then cooled and diluted with 128 g of water, then neutralized with 50% sodium hydroxide to pH 8.4.

Test No. 9

According to step c) of the inventive method, in a 0.25 liter glass reactor equipped with a mechanical agitation and an electric heater, mix:
80 g of Polyglykol™ M 2000 sold by the company CLARIANT™, in molten form,
0.24 g of lithium hydroxide,
13.8 g of the homopolymer of dry methacrylic acid obtained by the drying method described above,
0.20 g of Doverphos™ 10 sold by the company DOVER CHEMICAL™.

According to step d) of the invention, the esterification reaction then occurs. The whole assembly is then degassed by a current of nitrogen for 20 minutes. While agitating, the temperature is then gradually increased to 210° C., and the whole assembly is placed in a vacuum (20 mm of mercury) with this increase in temperature taking 60 minutes. The mixture is then cooked for 30 minutes at 210° C. The whole assembly is then cooled and diluted with 128 g of water, then neutralized with 50% sodium hydroxide to pH 8.4.

The results obtained appear in table 1.

TABLE 1

| Test no. | 1 | 2 | 3 | 4 | 5 |
|---|---|---|---|---|---|
| Prior Art (PA)/ | PA | PA | IN | IN | IN |
| INvention (IN) | | | | | |
| IAᵢ (mg KOH/ | 83 | 83 | 86 | 188 | 140 |
| mg polymer) | | | | | |
| IA_{f} (mg KOH/ | 34 | 35 | 30 | 130 | 70 |
| mg polymer) | | | | | |
| M_{w} (g/mole) | 155600 | 198000 | 73950 | 51200 | 64400 |
| Grafting rate (% methoxy | 57 | 56 | 79 | 91 | 86 |
| grafted) | | | | | |

| Test no. | 6 | 7 | 8 | 9 |
|---|---|---|---|---|
| Prior Art (PA)/ | IN | IN | IN | IN |
| INvention (IN) | | | | |
| IAᵢ (mg KOH/ | 160 | 86 | 86 | 86 |
| mg polymer) | | | | |
| IA_{f} (mg KOH/ | 80 | 30 | 30 | 30 |
| mg polymer) | | | | |
| M_{w} (g/mole) | 61400 | 69200 | 78100 | 63400 |
| Grafting rate (% methoxy | 91 | 90 | 96 | 95 |
| grafted) | | | | |

These results clearly demonstrate that the high-temperature direct esterification of a methacrylic polyacid is performed with high outputs if the disappearance of the acid function is considered. On the other hand, the high content of free polyoxyethylene groups, as with the high molecular mass of the final polymer, demonstrates that the methoxy polyoxyethylene groups are not stable at the temperatures where the polymethacrylic acid functionalizes. This leads to a thermal degradation of the comb polymer, producing a release of the hanging polyoxyethylene chains.

In contrast, the implementation of an antioxidant enables, while preserving a degree of substitution identical to the level of the carboxylic functions, to obtain a grafted polymer whose molecular weight is lower, and with a content of polyoxyethylene groups that is lower than in tests 1 and 3: the output of the method of the prior art is therefore greatly improved.

1. A method of manufacturing at least one comb polymer comprising a main (meth)acrylic chain and polyoxyalkylated lateral groups, comprising:
a) producing a solution comprising at least one homopolymer and/or copolymer of (meth)acrylic acid with at least one other monomer,
b) drying the solution obtained in a), in view of obtaining a homopolymer and/or a copolymer of (meth)acrylic acid with the at least one other monomer in a dry state,
c) mixing the product in a dry state obtained in b) with at least one alkoxy polyoxyalkylene glycol in a molten state, and/or at least one alkoxy polyoxyalkylene amine in a molten state, and/or at least one alkylene oxide in a liquid or gaseous state,
d) functionalizing the homopolymer and/or copolymer of (meth)acrylic acid by:
esterification with at least one alkoxy polyoxyalkylene glycol; and/or
amidification with at least one alkoxy polyoxyalkylene amine; or
ethoxylation with at least one alkylene oxide.
and wherein an antioxidant is added during a) and/or b) and/or c).

2. A method according to claim 1, wherein the antioxidant is an amine comprising at least one aromatic group substituted by an alkyl chain.

3. A method according to claim 1, wherein the antioxidant is an organophosphate compound.

4. A method according to claim 1, wherein c) is carried out at a temperature between 150° C. and 250° C.

5. A method according to claim 1, wherein c) is carried out in the presence of a catalyst.

6. A method according to claim 1, wherein the at least one alkoxy polyoxyalkylene glycol is a methoxy polyoxyalkylene glycol.

7. A method according to claim 1, wherein the at least one alkoxy polyoxyalkylene amine is a methoxy polyoxyalkylene amine.

8. A method according to claim 1, wherein the at least one alkylene oxide is an ethylene oxide, or a propylene oxide, or a mixture of ethylene oxide and propylene oxide.

9. A method according to claim 1, wherein the homopolymer and/or copolymer of (meth)acrylic acid is obtained by radical polymerization in solution, in a direct emulsion, in the presence of at least one catalytic system and at least one transfer agent, or by controlled radical polymerization.

10. A method according to claim 1, wherein the at least one other monomer of the copolymer of (meth)acrylic acid is at least one selected from the group consisting of:
an ethylene-unsaturated anionic monomer with a monocarboxylic group,
an ethylenically-unsaturated monomer with two carboxylic groups, an ethylenically-unsaturated monomer with a sulfonic group, an ethylenically-unsaturated monomer with a phosphoric group, an ethylenically-unsaturated monomer with a phosphonic group, vinylcaprolactone, vinylpyrrolidone, and
a water-insoluble monomer.

11. A method according to claim 1, wherein the drying of the homopolymer and/or copolymer of (meth)acrylic acid carried out in b) is performed in a dryer by atomization.

12. A method according to claim 1, wherein the drying of the homopolymer and/or copolymer of (meth)acrylic acid performed in b) is carried out until a solids content level greater than 80% is achieved according to a measurement by a METTLER-TOLEDO™ HR83 halogen moisture analyzer, wherein the measurement is carried out by drying at 150° C. until a loss of mass less than 1 mg is achieved for 30 seconds.

13. A method according to claim 1, further comprising e) occurring after d), which comprises placing the product obtained at the end of d) into an aqueous solution, then optionally fully or partially neutralizing said product with at least one neutralization agent.

14. A method according to claim 13, wherein the at least one neutralization agent is at least one selected from the group consisting of an agent with a monoequivalent neutralizing capacity, an agent with a two equivalent neutralizing capacity, an agent with a three equivalent neutralizing capacity, and an agent with more than a three equivalent neutralizing capacity.

15. A comb polymer, obtained by a method according to claim 1, comprising a main (meth)acrylic chain and grafted polyoxyalkylated lateral groups, with a grafting rate greater than 70%, as measured by GPC.

16. The comb polymer, in a dry state, according to claim 15, exhibiting a dry solids rate greater than 80% according to a measurement by a METTLER-TOLEDO™ HR83 halogen moisture analyzer, wherein the measurement is carried out by drying at 150° C. until a loss of mass less than 1 mg is obtained for 30 seconds.

17. A comb polymer, obtained by a method according to claim 1, in an aqueous solution, comprising a main (meth)acrylic chain and grafted polyoxyalkylated lateral groups, wherein the comb polymer exhibits a grafting rate greater than 70%, as measured by GPC.

18. A formulation comprising at least one mineral or organic material, and at least one comb polymer according to claim 15.

19. The formulation according to claim 18, in an aqueous form, wherein said formulation is
an aqueous dispersion or suspension of mineral or organic materials, optionally comprising a dispersion agent and/or a grinding aid agent and/or an anti-sedimentation agent and/or a thickening agent,
or
an aqueous composition comprising at least one hydraulic binder.
